(19) United States
(12) Patent Application Publication
(10) Pub. No.: US 2004/0116545 A1
(43) Pub. Date: Jun. 17, 2004

(54) Two-component foam system for producing constructional foams and their use

(76) Inventors: Petra Jakobstroer, Landsberg (DE); Wolfgang Schulz-Hanke, Untermeitingen (DE); Christian Forg, Dillishausen (DE)

Correspondence Address: DAVID TOREN, ESQ., SIDLEY, AUSTIN, BROWN & WOOD, LLP, 787 SEVENTH AVENUE, NEW YORK, NY, 10019-6018, US

(21) Appl. No.: 10/668,813

(22) Filed: Sep. 22, 2003

(30) Foreign Application Priority Data
Sep. 23, 2002 (DE) 102 44 171.5

(51) Int. Cl. B01D 19/02

(52) U.S. Cl. 516/115

(57) ABSTRACT

A two-component foam system for producing foams for construction purposes includes, with a polyol component (A), which contains at least one polyol, optionally a catalyst for the reaction of the polyol with the polyisocyanate, water, and an acqueous polymer dispersion, and a polyisocyanate component (B), which contains at least one polyisocyanate, the qualitative ratio of polyol(s) to polyisocyanate(s) being matched so that, when the polyol component (A) is mixed as specified with the polyisocyanate component (B), a molar ratio of isocyanate groups of the polyisocyanate to OH groups of the polyols (NCO:OH ratio) of 1:5 to 10:1 is obtained.

### BACKGROUND OF THE INVENTION

1. Field of Invention

The present invention relates to a two-component foam system for producing foams for construction purposes, with a polyol component (A), which contains at least one polyol, optionally a catalyst for the reaction of the polyol with the polyisocyanate, water and/or a blowing agent based on a compressed or liquefied gas as foaming agent and a polyisocyanate component (B) as specified, which contains at least one polyisocyanate, the quantitative ratio of polyol(s) to polyisocyanate(s) being coordinated so that, when the polyol component (A) is mixed with the polyisocyanate component (B), a molar ratio of isocyanate groups of the polyisocyanate to the OH groups of the polyols (NCO:OH ratio) of 1:5 to 10:1 and preferably of 1:1 to 2:1 results, and the use of such a two-component foam system for constriction purposes.

2. Description of the Prior Art

It is already known that in situ foams and molded parts based on polyurethane foams can be used to fill openings in ceilings and walls of building, particularly as fire protection. Since the conventional polyurethane foams, such as the normally used constructional foams, do not have adequate fire-protection properties for this application, these foams are provided with liquid and solid fire protection additives, as well as with inorganic fillers, in order to achieve the required five-protection duration. In addition, special basic polyurethane materials and phosphorous-containing polyols are used.

A further possibility for improving the fire-protection properties of polyurethane foams consists of painting the foam, introduced into the opening that is to be protected, with a file-protection coating. This fire-protection coating may, for example, be an intumescing coating, that is, contain components, which foam when heated to the fire temperature and, in this way, form an insulating layer between the fire and the foam.

Moreover, the German Offenlegungsschriften 37 32 203 and 39 42 841 discloses that foams, based on polyurethane, can be impregnated with organic binders containing solids, in order to achieve in this way that the polyurethane foam does not melt and drip in the event of a fire and is self-extinguishing.

The object of the German patent 199 55 839 is the use of plastic foams containing swellable fillers in order to seal feed-throughs in masonry. In this case, however, the object is to prevent the penetration of water through gaps in the masonry, sealed with the help of these plastic foams, into the interior of the building by the swelling of the swellable polymers in water.

Finally, for filling joints and smaller openings in buildings, sealing compositions are known, which are based on copolymers of acrylate esters which, in combination with inorganic fillers, such as plaster or chalk, have a very advantageous burning behavior and form a stable ash crust. However, these sealing compositions do not foam and can therefore be used exclusively for filling narrow joints and small openings.

However, none of these previously known materials for filling openings in fire-protection ceilings and walls are able to provide complete satisfaction, since they require liquid or solid fire-protection additives, which raise the cost of material and production appreciably, or solid additives and inorganic fillers, which increase the viscosity of the reactive starting substance, as a result of which the in situ processing is made far more difficult. For example, the force required to discharge a two-component foam system from a multi-chamber cartridge increases appreciably if the viscosity of the components is higher. Furthermore, even if special, reinforcing additives are added, the cohesion of the ash crust, formed in the event of a fire, is relatively low, so that pieces of the ash crust can fall out of the opening, which is to be sealed, so that the integrity of the seal is endangered.

The additional painting of a foam, introduced in an opening, is a further step in the process, requires additional time and involves additional costs, quite apart from the fact that additional material is required.

Admittedly, sealing compositions based on acrylate dispersions are relatively inexpensive and require only small additions of fire-protection agents. However, they do not foam and therefore are not suitable for sealing larger openings or joints or cable and pipe lead-throughs.

An object of the present invention is a two-component foam system for the production of foams for building purposes of the type defined above, which can be introduced easily into the openings or joints or cable or pipe lead-throughs in walls and ceilings of buildings and, while being fire resistant for a long period, makes improved thermal insulation and fire-protection properties possible in the absence of additional fire-protection additives, and with which it is possible to produce foam, which has surprisingly advantageous mechanical properties because of its fibrous structure, even in situ at the construction site.

### SUMMARY OF THE INVENTION

This and other objects of the present invention, which will become apparent hereinafter, are achieved with a two-component foam system for producing foams for construction purposes, with a polyol component (A), which contains at least one polyol, optionally a catalyst for the reaction of the polyol with the polyisosyanate, water and/or a blowing agent based on a compressed or liquefied gas as foaming agent, and a polyisosyanate component (B), which contains at least one polyisosyanate, the quantitative ratio of polyol(s) to polyisocyanate(s) being coordinated so that, when the polyol component (A) is mixed with the polyisocyanate component (B) as specified, a molar ratio of isocyanate groups of the polyisocyanate to the OH groups of the polyols (NCO:OH ratio) of 1:5 to 10:1 and preferably of 1:1 to 2:1 results, which is characterized in that the polyol component (A) contains an aqueous polymer dispersion.

Surprisingly, it has turned out that, due to the presence of an aqueous polymer dispersion in the polyol component, such a two-component foam system for producing polyurethane foams can achieve particularly advantageous results with respect to the handling of this two-components foam system as well as with respect to the properties of the foam formed therefrom during foaming.

Accordingly, when the foam system is used as intended and the isocyanate component (B) has been added to the inventive polyol component (A), coagulation and precipitation of the polymer from the polymer dispersion take place, as a result of which the foam, which is forming, very rapidly assumes a sufficient stability and does not drip or flow. This is particularly advantageous for using the inventive two-component foam as an in situ foam especially when doorframes, window frames or facade elements are fastened, because the required strength of the foam is achieved rapidly by these means.

Furthermore, it has turned out that, when the polymer of the aqueous polymer dispersion is coagulated and precipitated in the foaming foam, the polymer, precipitated from the aqueous dispersion, is stretched in the direction in which the foam expands. This leads to an anisotropic, fiber-like structure of the foam, so that the strength properties of the foam can be adjusted differently in the various spatial directions. Depending on the geometry of the surrounding mold, in which the foam system is formed, it becomes possible, in this way, to increase the stability of the foam selectively in a particular direction. For example, by foaming in an elongated mold, it is possible to obtain a foam, which has a higher strength in the longitudinal direction of the container than in the transverse direction.

On the other hand, a surprising improvement in the fire resistance arises owing to the fact that, in the event of a fire, the burned foam leave behind a stable ash crust, which impedes the further spread of the fire, while polyurethane foams, which have been foamed without the inventive addition of an aqueous polymer dispersion, burn under the same conditions without leaving a residue.

In contrast to the methods of the state of the art, which have been addressed above and according to which a finished polyurethane foam is impregnated or infused with a binder, such as an acrylate ester copolymer containing carboxyl groups or a synthetic resin dispersion, the polymer of the aqueous polymer dispersion, present in the polyol component, is incorporated in the structure of the polyurethane foam produced during the foaming of the inventive two-component foam system in the specified manner, as a result of which the properties of the polyurethane foam are improved in a surprising manner particularly with respect to the fire-protection behavior and the mechanical properties.

For example, as a result of the incorporation of the polymer of the aqueous polymer dispersion into the polyurethane foam system, very good fire properties result without the addition of further fire-protection additives or fillers. However, the fire-protection effect of the previously existing fire-protection foams can be exceeded clearly by the addition of relatively small amounts of such additives. In this way, it is possible, in comparison to conventional fire-protection foams, to achieve the same fire resistance duration with the inventive two-component foam systems at a lesser depth of incorporation. It is therefore possible to use the inventive two-component foam systems also for very thin fire-protection walls and ceilings.

It has furthermore turned out that the inventive two-component foam system produces a cured polyurethane foam, which, because of the presence of the polymer of the aqueous polymer dispersion, incorporated in the foam structure, provides an extremely stable ash crust, which is responsible for the improved fire-protection properties in the event of a fire.

Due to the use of the advantageously priced starting materials, and, optionally, of smaller amounts of fire-protection additives, the material costs and manufacturing costs can be kept comparatively low. Moreover, it is possible to lower material costs for this application, since the fire resistance duration aimed for can be obtained already at a depth of incorporation, which is less than in the case of conventional fire-protection foams.

Furthermore, because the amount of solid filler added is less and the proportion of water is greater, the viscosity of the polyol component of the inventive of the two-component foam system is appreciably lower than that of conventional foam systems. As a result, the processing is simplified appreciably, since the force employed for the manual and mechanical discharging of the components of the two-component foam system, present in separate containers, is decreased clearly.

A rigid foam, as well as a flexible foam can be produced by a varying the ratio of polyol component to isocyanate component. The foam can therefore be used particularly for filling fire-protection joints. Pursuant to the invention, the proportion of polyisocyanate component is less than in the case of conventional polyurethane foams. This reduces any possible danger to health during the production and packaging of the foam as well as during its processing.

In accordance with a preferred embodiment of the invention, the aqueous polymer dispersion of the two-component foam system contains, as polymer at least one representative of the group comprising polyurethanes, polyvinyl, acetates, polyvinyl ethers, polyvinyl propionates, polystyrenes, natural or synthetic rubbers, especially rubber latexes, poly(meth)acrylates and homopolymers and copolymers based on (meth)acrylates, acrylonitrile, vinyl esters, vinyl ethers, vinyl chloride and/or styrene. Preferred polymers of the aqueous polymer dispersion are poly(methacrylate alkyl esters), poly(acrylate alkyl esters), poly(methacrylate aryl esters), poly(acrylate aryl esters), the alkyl group having 1 to 18 carbon atoms and preferably 1 to 6 carbon atoms and unsubstituted or substituted phenol or naphthyl groups being contained as aryl groups as well as copolymers of these polymers with n-butyl acrylate and/or styrene.

In accordance with a preferred embodiment of the invention, the polyol component (A) contains 20 to 300 parts by weight and preferably 50 to 150 parts by weight of the polymer or polymers of the aqueous polymer dispersion added per 100 parts by weight of the polyols, which are contained in polyol component (A).

The aqueous polymer dispersion preferably has a water content of 5 to 80% by weight and preferably of 20 to 60% by weight and, for example, 70% by weight and, in accordance with an advantageous embodiment of the invention, is contained in such an amount in the polyol component (A), that the water content of the polyol component (A) is 6 to 100 parts by weight and preferably 20 to 60 parts by weight, per 100 parts by weight of the polyol or polyols in the polyol component (A). This amount of water is more than that required for foaming the polyol or polyols with the polyisocyanate component, in order to bring about the desired foaming of the polyurethane.

In accordance with a further, preferred embodiment of the invention, the polyol component (A) contains, as polyol, at least one representative of the group comprising linear or branched, aliphatic, aromatic and/or araliphatic, monomeric or polymeric polyols, polyester polyols, polyether polyols, fatty acid polyester polyols, aminopolyols and halogenated polyols, preferably with molecular weights ranging from 200 to 10,000 and 2 to 6 hydroxyl groups, especially polyethylene glycol, polypropylene glycol and polybutylene glycol with a number average molecular weight of 200 to 3,000 and preferable of 300 to 600, polyester polyols and/or polyether polyols with a functionality of 1.5 to 5 and an OH number of 100 to 700, whereas the polyisocyanate component (B) preferably contains a polyisocyanate with a functionality of at least 2 and an NCO content of 20 to 40%.

Furthermore, it is advantageous pursuant to the invention that the polyol component (A) contains at least one cell stabilizer for the foam that is to be formed in an amount of 0.01 to 5% by weight and preferably of 0.1 to 1.5% by weight. Particularly suitable as cell stabilizers are polysiloxanes, polyether-modified siloxanes, siloxane-oxyalkylene copolymers, silicones, nonionic emulsifiers of average polarity and especially silicone glycol copolymers, polydimethylsiloxane, polyoxyalkylene glycol-alkylsilane copolymers, alkoxylated fatty acids, preferably ethoxylated or proproxylated fatty acids for 14 carbon atoms in the acid group, ethoxylated (C₁ to C₁₈) alkylphenols and/or ethoxylated castor oil.

To improve the burning behavior of the foamed foam system further, the polyol component (A) of the inventive, two-component foam system preferably contains an intumescing material, such as expanding graphite, expandable perlite and/or vermiculite, especially graphite intercalated with sulfuric acid, or the starting materials for chemically intumescing compositions, such as melamine and melamine derivatives, polyphosphates, sodium silicate and sources of carbon.

As catalyst for the reaction of the polyol with the polyisocyanate, the polyol component (A) of the inventive foam system may contain an aromatic, heteroaromatic and/or aliphatic, secondary or tertiary amine and/or an organometallic compound of a metal from the group comprising Zn, Sn, Mn, Mg, Bi, Sb, Pb and Ca, especially an octoate, naphthenate or acetylacetonate of one of these metals. Catalysts, which are particularly preferred, are dimethylmonoethanolamine, diethylmonoethanolamine, methylethylmonoethanolamine, triethanolamine, trimethanolamine, tripropanolamine, tributanolamine, trihexanolamine, tripentanolamine, tricyclohexanolamine, diethanolmethylamine, diethanolethylamine, diethanolpropylamine, diethanolbutylamine, diethanolpentylamine, diethanolhexyl-amine, diethanolcyclohexylamine, diethanolphenylamine, as well as their ethoxylated and propoxylated products, diazabicyclooctane, especially 1,4-diazabicylo[2.2.2]octane, triethylamine, dimethylbenzylamine, bis(dimethylamino-ethyl) ether, tetramethylguanidine, bis-dimethylaminomethyl phenol, 2,2-dimorpholinodiethyl ether, 2-(2-dimethylaminoethoxy)-ethanol, 2-dimethylamino-ethyl-3-dimethylaminopropyl ether, bis(2-dimethylaminoethyl) ether, N,N-dimethylpiperazine, N-(2-hydroxyethoxyethyl)-2-azanorbornane, N,N,N,N-tetramethylbutane-1,3-diamine, N,N,N,N-tetramethylpropane-1,3-diamine, N,N,N,N-tetramethylhexane-1,6-diamine, 1-methylimidazole, 2-methyl-1-vinylimidazole, 1-allylimidazoe, 1-phenylimidazole, 1,2,3,4,5-tetramethylimidazole, 1-(3-aminopropyl)-imidazole, pyrimidazole, 4-dimethylamino-pyridine, 4-pyrolidinopyridine, 4-morpholinopyridine, 4-methylpyridine, N-dodecyl-2-methylimidazole, as well as tin(III) salts of carboxylic acids, strong bases, such as alkali hydroxides, alkali alcoholates and alkali phenolates, particularly d-n-octyl tin mercaptide, dibutyl tin maleate, dibutyl tin diacetate, dibutyl tin dilaurate, dibutyl tin dichloride, dibutyl tin bis-dodecyl mercaptide, tin(III) acetate, tin(III) ethylhexoate and tin(III) diethylhexoate, as well as lead phenyl ethyl dithiocarbaminate.

Preferably, the polyisocyanate component (B) of the inventive, two-component foam system contains a polyisocyanate, which is selected from the group comprising aliphatic, cycloaliphatic, araliphatic, aromatic and heterocyclic polyisocyanates, in particular, phenyl isocyanate, 1,5-naphthylene diisocyanate, 2,4- or 4,4′-methylenedi(phenyl isocyanate) (MDI), hydrogenated MDI, xylene diisocyanate (XDI), m- and p-tetramethylxylene diisocyanate, 4,4′-diphenyldimethylmethane diisocyanate, di- and tetralkyldiphenylmethane diisocyanate, 4,4′dibenzyl diisocyanate, 1,3-phenylene diisocyanate, 1,4-phenyl diisocyanate, the isomers of toluylene diisocyanate, chlorinated and brominated diisocyanates, phosphorous-containing diisocyanates, 4,4′-diisocyanotphenyl-perfluorethane, tetramethoxybutane-1,4-diisocyanate, 1,4-butane diisocyanate, 1,6-hexane diisocyanate, dicyclohexylmethane diisocyanate, 1,4-cyclohexane diisocyanate, ethylene diisocyanate, bis-isocyanatoethyl phthalate, 1-chloromethylphenyl-2,4-diisocyanate, 1-bromomethylphenyl-2,6-diisocyanate, 3,3-bis-chloromethylethyer-4,4-diphenyl diisocyanate, trimethylhexamethylene diiso-cyanate, 1,4-diisocyanatobutane, 1,12-diisocyanatododecane and dimeric or oligomeric 2,4- or 2,6-toluylene diisocyanate, 2,4′- or 4,4′-methylenedi(phenyl isocyanate), isopropylidene diisocyanate and/or hexamethylene diisocyanate and or mixtures of these isocyanates.

Preferably, the polyol component (A) and/or the polyisocyanate component (B) may contain a blowing agent based on a compressed or liquefied gas, such as air, nitrogen, carbon dioxide, nitrous oxide, a fluorinated hydrocarbon, such as 1,1,1,2-tetrafluoroethane or 1,1,1,2,3,3,3-hexafluoropentane, dimethyl ether, butane, propane or mixtures thereof, in order to intensify the foaming action, which is achieved due to the presence of the water in the polyol component (A).

Furthermore, it is possible, pursuant to the invention, to add a conventional organic or inorganic flame retardant in a total amount of 0.1 to 20% by weight and preferably 0.5 to 5% by weight to the polyol component (A) or to the polyisocyanate component (B) or to both components.

As flame retardant of this type, red phosphorus, phosphorus compounds, particularly triethyl phosphate, triphenyl phosphate and/or halogenated phosphate esters, such as trichloroethyl phosphate, tris(2-chloroisopropyl) phosphate or tris(2-chloroethyl) phosphate, metal hydroxides, especially aluminum hydroxide or magnesium hydroxide, zinc borate, ammonium polyphosphate and/or antimony oxide, can be added.

In accordance with a further, preferred embodiment of the invention, the polyol component (A) of the inventive two-component foam system contains an agent, which accelerates the coagulation of the polymer dispersion. Surprisingly, it has turned out that such a coagulating agent can be incorporated in the polyol component (A) without coagulating the polymer dispersion therein. This evidently is a consequence of the fact that the polyol present inhibits the coagulation resin. Only after the isocyanate component (B) has been added, do the coagulation, which is accelerated by the coagulating agent, and the precipitation of the polymer of the polymer dispersion take place with the result that the foam that is forming has sufficient stability even more quickly, does not drip nor flow.

Due to the addition of the agent for accelerating the coagulation of the aqueous polymer dispersion, the precipitation and coagulation of the polymer in the foaming foam can be accelerated and, with that, the strength properties of the foam can be affected even more selectively.

As agents, suitable pursuant to the invention for accelerating the precipitation and coagulation of the polymer from the aqueous polymer dispersion, finely divided solids, salts or oxides of multivalent metals, such metals of the alkaline earth elements, of zinc, aluminum or iron, or an organic acid may be used. Especially preferred salts of this type are calcium nitrate, zinc nitrate, zinc oxide, aluminum sulfate, aluminum chloride, iron sulfate and iron chloride can be used, The particle size of the finely divided solids extends from 50 nm to 1 mm and preferably from 10 nm to 0.1 mm.

Furthermore, compounds, which lower the pH, such carboxylic acids, for example formic acid and acetic acid, or also polyacrylamide, are suitable as agents for accelerating the precipitation and coagulation of the aqueous polymer dispersion. Ammonium polyphosphate, which has the additional advantage of acting also as a flame retardant additive, is a particularly preferred agent for coagulating the aqueous polymer dispersion.

Furthermore, finely divided inorganic and/or organic fillers are also suitable as agents for accelerating the precipitation and coagulation of the polymer form the aqueous polymer dispersion and comprised, for example, inorganic fillers selected from the group comprising metal oxides, borates, carbonates, preferably chalk, silicates, kaolin, glass powder, iron oxide, titanium oxide, silica, inorganic foams, preferably foamed, expanded clay, foamed perlite and foamed vermiculite and/or hollow spheres of silicate material or glass, and organic fillers based on particulate and/or fibrous, vegetable and/or animal polymers, particular based on potatoes, corn, rice, grain, wood, cork, paper, leather, cellulose, hemp, cotton and wool, preferably starch.

These agents for coagulating the aqueous polymer dispersion can be combined pursuant to the invention, with coagulating aids, such as ester alcohols, for example, 2,2,4-trimethyl-1,3-dihydroxypentane monoisobutyrate, or also with glycols.

Moreover, it is possible to add a thixotropic agent and/or a diluent or solvent to the polyol component (A) and the polyisocyanate component (B) to control the rheological behavior and the viscosity. Thixotropic agents, preferred pursuant to the invention are silica, phyllosilicate, especially synthetic magnesium phyllosilicate, activated bentonite, sepionite or attapulgite, polyethylene wax and/or cellulose derivatives, such hydroxyethylcellulose.

Pursuant to the invention, it is furthermore possible to add at least one inorganic and/or organic filler to the polyol component (A) and/or polyisocyanate component (B) in order to control the processing properties of the two-component foam system as well as the properties of the foam produced from the foam system. Preferably, metal oxides, borates, carbonates, preferably chalk, silicates, kaolin, glass powder, iron oxide, titanium oxide, silica, inorganic foams, preferably foamed, expanded clay, foamed perlite and foam vermiculite and/or hollow spheres of silicate material or glass, are used as inorganic fillers.

As organic filler, a particulate and/or fibrous vegetable and/or animal polymer, especially one based on potatoes, corn, rice, grain, wood, cork, paper, leather, cellulose, hemp, cotton and wool, preferably starch, can be added to the inventive two-component foam system.

Finally, it is possible to use known auxiliary and additive materials, stabilizers, plasticizers, catalysts, solvents, pigments and/or dyes additionally in the polyol component (A) and/or the polyisocyanate component (B). As plasticizer, an ester, based on phthalic acid, adipic acid, sebacic acid, phosphoric acid, citric acid or a fatty acid may be used:

According to a further, preferred embodiment, the polyol component (A) and the polyisocyanate component (B) of the inventive two-component foam system are contained separately in a two-chamber or multi-chamber device so as to inhibit any reaction and, under use conditions, caused to react, while the ratio of the NCO groups of polyisocyanate or of the polyisocyanate to the OH groups of the polyol or the polyols of 1:5 to 10:1 and preferably of 1:1 two 2:1 is maintained. When the two-component foam system is used as specified, the components, present in the separate containers of the two-chambers or the multi-chamber device are then expressed through a mixing nozzle under the action of mechanical forces or under the action of the blowing agent present in the components and extruded either into a mold and foamed there or introduced foamed and cured in situ at the construction site in the openings, which are to be closed off.

The invention therefore also relates to the use of the above-described two-component foam system for filling openings, cable and pipe lead-throughs in walls, floors and/or ceilings, joints between ceiling parts and wall parts, between masonry openings and construction parts, which are to be installed, such a window frames and door frames, between ceilings and walls and between exterior walls and facades of buildings in front of such walls with foam for the purpose of fastening, thermal isolation and fire protection.

### DETAILED DESCRIPTION OF THE PREFERRED EMBODIMENTS

The invention will now be described in detail with reference to the following examples.

### EXAMPLE 1

The components of the polyol component (A) and of the polyisocyanate component (B) of the two-component foam system of this Example 1 are listed in the following Table 1.

TABLE 1

| | | % by wt. |
|---|---|---|
| Polyol Component (A) | | |
| Aromatic polyester polyol | Terol 198 | 9.2 |
| Aqueous dispersion of an acrylate | Acronal V271 | 21.6 |
| ester copolymer | | |
| Polyethylene glycol (MW 600) | Pluracol E 600 | 9.2 |
| Ethoxylated castor oil | Emulan EL | 2.4 |
| Silicon glycol copolymer | Dabco DC 190 | 0.5 |
| 33% Tertiary amine* (FS), 67% | Dabco LV 33 | 0.5 |
| dipropylene glycol as solvent | | |
| Water | | 4.1 |
| Zinc borate | Firebrake ZB 290 | 3.1 |
| Expanded graphite (graphite | Nord-Min 249 | 5.2 |
| intercalated with sulfuric acid) | | |
| Not expanded vermiculate, with a | Vermiculite | 20.4 |
| particle size of 0.3-1 mm | | |
| Iron oxide | Bayferrox | 2 |
| Coconut shell flour | Coconit 300 | 6.4 |
| Hollow glass spheres | Fellite | 6.4 |
| Polyisocyanate component (B) | | |
| Polymeric (4,4′-methylene | Voranate M220 | 9 |
| diphenylisocyanate) (MDI) | | |
| | | 100.0 |

*1,4-diazabicyclo (2.2.2) octane

For preparing the polyol component (A), the aromatic polyester polyol is first of all mixed with the aqueous dispersion of the poly(n-butyl acrylate)-styrene copolymer and the polyethylene glycol. The remaining liquid components are then mixed in and finally the solids are stirred in.

The polyol component (A) and the polyisocyanate component (B) are then transferred to separate containers of a two-chamber device.

When the two components are mixed, the composition foams. The two components can be brought together and mixed in a bucket by means of a spatula or, with the help of the a two-chamber mixing or metering device, discharged from the multi-chamber device and brought together and mixed by an attached static mixer.

After the mixing, the foaming reaction commences in about 85 seconds and is concluded after about 500 seconds. A flexible foam with a density of 225 kg/m³ results.

After the curing, the duration of the fire resistance is measured using the using the unit temperature/time curve in accordance with the directions of the DIN 4012, part 2, at a pressure in the oven of 10 Pa. For this test, the foam is incorporated in an opening of the ceiling or wall of a fire oven. In the interior of the fire oven a flame is ignited, which is controlled so that the temperature in the oven corresponds to the so-called “unit temperature profile” given in this DIN. This means, for example, that a temperature of about 850° C. is reached after about 30 minutes and a temperature of 925° C. after 60 minutes. The duration of the fire resistance, that is, of the time during which penetration of the fire from the inside of the oven to the outside is prevented, is determined. For the duration of the test, a flame must not be visible from the outside and the temperature at the outside of the material must not exceed a value of a 180° K above room temperature. Moreover, a cotton pad, held at the surface of the material, must not ignite. At an installed depth of the foam of 12 cm, the duration of the fire resistance in this test is 130 minutes and the maximum difference between room temperature and the outside of the foam is 41° K.

For comparison purposes a conventional, commercial, flexible fire protection foam with a density of 260 kg/m³ sold by the applicant under the name of Hilti CP 657, is tested under the same conditions at an installed depth of 15 cm. With this material, a difference of 74° K between room temperature and the outside temperature is reached already after 60 minutes. With that, it can be seen that the inventive two-component foam system has clearly superior thermal isolation properties.

### EXAMPLE 2

The components for preparing the polyol component (A) and the polyisocyanate component (B) are listed in the following Table 2.

TABLE 2

| | | % by wt. |
|---|---|---|
| Polyol Component (A) | | |
| Aqueous dispersion of an acrylate ester | Acronal V271 | 25 |
| copolymer | | |
| Polyethylene glycol (MW 600) | Pluracol E 600 | 26.5 |
| Ethoxylated alkylphenol | Emulan OP 25 | 3.5 |
| Ammonium polyphosphate | APP 422 | 3.5 |
| Expanded graphite (graphite intercalated | Nord-Min 249 | 4.8 |
| with sulfuric acid) | | |
| Vermiculite 0.3-1 mm | Vermiculite | 6 |
| Iron oxide | Bayferrox | 3.1 |
| Coconut shell flour | Coconit 300 | 8.6 |
| Polyisocyanate component (B) | | |
| Polymeric isocyanate (4,4′-methylene | Voranate M220 | 19 |
| di(phenyl isocyanate) (MDI) | | |
| | | 100 |

The components of the polyol component (A) are also produced in the manner described above by initially mixing the liquid components and then stirring the solid components.

When the two components are mixed either by being discharged from a two-chamber device or by being stirred, there is a very rapid, great increase in viscosity, which corresponds to a gelling time of 15 seconds and can be attributed to the fact that the polymer dispersion is precipitated and coagulated with the formation of a gel.

Because of this gel formation, the foaming foam material already has a very high stability after about 15 second and does not drip or flow.

This property is very desirable when the two-component foami system is used in situ at the construction site, for example, when doorframes are fastened. For this purpose the foam is introduced between the wall and the doorframe. In the case of conventional, two-component polyurethane foams, sufficient stability is achieved only owing to the fact the discharging process is slowed down to such an extent that the foam expands and polymerizes already in the mixer, which leads to a longer working time and frequently to a blockage of the mixing device. On the other hand, pursuant to the invention, due to the addition of the aqueous polymer dispersion to the polyol component (A) of the foam system, the stability is very high early on, so that prompt processing of the two-component foam is readily possible.

Moreover, the polymer of the aqueous polymer dispersion, precipitated and coagulated from the aqueous dispersion, is stretched in the direction, in which the foam expands, so that anisotropic, fibrous structure of the foam results. Accordingly, different strength in different spatial directions can be achieved, depending on the geometry of the surrounding mold.

TABLE 3

| | | % by wt. |
|---|---|---|
| Polyol Component (A) | | |
| Aqueous dispersion of an acrylate ester | Primal 2620 | 35.6 |
| copolymer (38% by weight water) | | |
| Polyethylene glycol (MW 600) | Pluracol E 600 | 34 |
| Ethoxylated alkylphenol | Emulan OP 25 | 5 |
| Polyisocyanate component (B) | | |
| Polymeric isocyanate (4,4′-methylene | Voranate M220 | 25.4 |
| di(phenyl isocyanate) (MDI) | | |
| | | 100.0 |

The flexible foam, obtained by foaming the two-component foam system of this Example 2, shows after the gelling time, a starting time of 55 seconds and a stopping time 450 seconds and provides a foam with a density of 140 kg/m³. At an installed depth of 15 cm, the duration of the fire resistance, measured in the above manner, is 120 minutes and the difference between room temperature and the temperature at the outside of the material is only 52° K. With that, this foam is also clearly superior in its thermal insulation properties to the convention, flexible fire-protection foam described in example 1.

### EXAMPLE 3

To begin with, the components of the polyol component (A) are mixed in a beaker by intimate stirring. The polyisocyanate component (B) is then added and mixed in immediately. Gel formation is observed in the mixture after 25 seconds and expansion of the composition commences after 80 seconds and is finished completely after 6 minutes. A flexible foam results with a bulk density 71 g/L.

For this formulation, 39 parts by weight of water and 64 parts by weight of dispersed polymer are contained in the mixture per 100 parts weight of polyol. The amount of water would be sufficient for the formation of 17 L of carbon dioxide per 100 g of foam. Considering the isocyanate component, which is required for this reaction, 4.2 L of carbon dioxide could be formed. Accordingly, the water is present in a fourfold over the amount required for the foaming.

However, after the expansion, a foam volume of only 1.4 L per 100 g of foam is observed. Since it can be excluded that larger amounts of carbon dioxide escape from the foam pores, since the whole of the carbon dioxide escaping was collected in a separate experiment and amounts to only 0.5 L per 100 g of foam, these experiments show that only a lower proportion of the water present, in this case about 10% by weight, is converted into carbon dioxide and, with that, required for the formation of the foam. Surprisingly, it is therefore unnecessary to reduce the water content of the polyol component in order to regulate the carbon dioxide formation since, pursuant to the invention, a polyurethane foam with outstanding properties is obtained in every case.

In the fire test, this material shows a very stable ash crust, whereas a polyurethane foam, which has been produced in a similar manner but without the addition of the aqueous dispersion of the acrylate ester copolymer, burned without leaving a residue.

Though the present invention was shown and described with references to the preferred embodiments, such are merely illustrative of the present invention and are not to be construed as a limitation thereof, and various modifications to the present invention will be apparent to those skilled in the art. It is, therefore, not intended that the present invention be limited to the disclosed embodiments or details thereof, and the present invention includes all of variations and/or alternative embodiments within the spirit and scope of the present invention as defined by the appended claims.

What is claimed is:

1. A two-component foam system for producing foams for construction purposes, comprising a polyol component (A) which contains at least one polyol, water, and an aqueous polymer dispersion; and a polyisocyanate component (B) which contains at least one polyisocyanate, the quantative ratio of the at least one polyol to the at least one polyisocyanate being matched so that, when the polyol component (A) is mixed as specified with the polyisocyanate component (B), a molar ratio of isocyanate groups of the polyisocyanate to OH groups of the polyol (NCO:OH ratio) of 1:5 to 10:1 is obtained.

2. The two-component foam system of claim 1, wherein the polyol component (A) contains a catalyst for reaction of the polyol with the polyisocyanate, and the molar ratio of isocyanate groups of the polyisocyanate to OH groups of the polyol (NCO:OH ratio) is 1÷2 to 2:4.

3. The two-component foam system of claim 1, wherein the aqueous polymer dispersion contains, as polymer, at least one representative of the group consisting of polyurethanes, polyvinyl agitates, polyvinyl ethers, polyvinyl propionates, polystyrenes, natural or synthetic rubbers, poly((meth)acrylates) and homopolymers and copolymers based on at least one of (meth)acrylates, acrylonitrile, vinyl esters, vinyl ethers, vinyl chloride, and styrene.

4. The two-component foam system of claim 3, wherein the aqueous polymer dispersion contains at least one of poly(alkyl methacrylate), poly(alkyl acrylate), poly(aryl methacrylate), poly(aryl acrylate), and copolymers thereof with at least one of n-butyl acrylate and styrene, as the polymer.

5. The two-component foam system of claim 1, wherein the polyol component (A) contains 20 to 300 parts by weight of the polymer or polymers of the aqueous polymer dispersion per 100 parts by weight of the at least one polyol of the polyol component (A).

6. The two-component foam system of claim 5, wherein the polyol component (A) contains 50 to 150 parts by weight of the polymer or polymers of the acqueous polymer dispersion per 100 parts by weight of the at least one polyol of the polyol component (A).

7. The two-component foam system of claim 1, wherein the aqueous polymer dispersion has a water content of 5 to 80% by weight.

8. The two-component foam system of claim 7, wherein the acqueous polymer dispersion has the water content of 20 to 60% by weight.

9. The two-component foam system of claim 1, wherein the aqueous polymer dispersion is contained in such an amount in the polyol component (A) that the water content of the polyol component (A) ranges from 6 to 100 parts by weight per 100 parts by weight of the at least one polyol of the polyol component (A).

10. The two-component foam system of claim 9, wherein the water content of the polyol component (A) ranges from 20 to 60 parts by weight per 100 parts by weight of the at least one polyol of the polyol component (A).

11. The two-component foam system of claim 1, wherein the polyol component (A) contains, as polyol, at least one representative of the linear or branched, aliphatic, aromatic and araliphatic, monomeric or polymeric polyols, polyester polyols, polyether polyols, fatty acid polyester polyols, amino polyols and halogenated polyols.

12. The two-component foam system of claim 11, wherein the polyol has a molecular weight raging from 200 to 10,000, and 2 to 6 hydroxyl groups, and is selected from the group consisting of polyethylene glycol, polypropylene glycol, and polybutylene glycol with an average molecular weight of 200 to 3,000, at least one of the polyester polyols and polyether polyols with a functionality of 1.5 to 5 and an OH number of 100 to 700, and wherein the polyisocyanate component (B) contains a polyisocyanate with a functionality of at least 2 and an NCO content of 20 to 40%.

13. The two-component foam system of claim 12, wherein polyethylene glycol, polypropelene glycol, and polybutylene glycol has each an average molecular weight of 300 to 600.

14. The two-component foam system of claim 1, wherein the polyol component (A) contains at least one cell stabilizer in an amount of 0.01 to 5% by weight.

15. The two-component foam system of claim 14, wherein the polyol component (A) contains at least one cell stabilizer in an amount of 0.1 to 1.5% by weight.

16. The two-component foam system of claim 14, wherein the polyol component (A) contains a cell stabilizer selected from the group consisting of polysiloxanes, polyether-modified siloxanes, siloxane-oxyalkylene copolymers, silicones, nonionic emulsifiers of average polarity, and silicone glycol copolymers, polydimethylsiloxane, polyoxyalkylene glycol-alkylsilane copolymers, alkoxylated fatty acids.

17. The two component foam system of claim 16, wherein fatty acids are selected from a group consisting of ethoxylated or proproxylated fatty acids with 14 carbon atoms in the acid group, ethoxylated (C₁ to C₁₈) alkyl phenols, and ethoxylated castor oil.

18. The two-component foam system of claim 1, wherein the polyol component (A) contains at least one intumescent material.

19. The two-component foam system of claim 18, wherein at least one of the expanded graphite and vermiculite is contained as intumescent material.

20. The two-component foam system of claim 1, wherein the polyol component (A) contains at least one of an aromatic and aliphatic, secondary or tertiary amine, an organometallic compound of a metal selected from the group containing Zn, Sn, Mn, Mg, Bi, Sb, Pb and Ca.

21. The two-component foam system of claim 20, wherein as organometallic compound of the metal selected from the group containing Zn, Sn, Mn, Mg, Bi, Sb, Ca, octoate, naphthenate or acetylacetonate of these metals is used as catalysts for reaction of the polyol with the polyisocyanate.

22. The two-component foam system of claim 1, wherein the polyisocyanate component (B) contains a polyisocyanate selected from the group consisting of aliphatic, cycloaliphatic, araliphatic, aromatic and heterocyclic polyisocyanates, especially 4,4′-methylene diphenylisocyanate, toluylene diisocyanate, isopropylidene diisocyanate, hexamethylene diisocyanate, and a prepolymer or an oligomer of these diisocyanates.

23. The two-component foam system of claim 1, wherein the polyol component (A) and the polyisocyanate component (B) contains a blowing agent based on a compressed or liquefied gas, selected from the group containing air, nitrogen, carbon dioxide, nitrous oxide, a fluorinated hydrocarbon, dimethyl ether, butane, and propane.

24. The two-component foam system of claim 23, wherein the fluorinated hydrocarbon is selected from the group containing 1,1,1,2-tetrafluoroethane and 1,1,1,2,3,3,3-hexafluoropentane.

25. The two-component foam system of claim 1, wherein at least one of the polyol component (A) and the polyisocyanate component (B) contains an organic or inorganic flame retardant.

26. The two-component foam system of claim 25, wherein the organic or inorganic flame retardant is contained in an amount of 0.1 to 20% by weight.

27. The two-component foam system of claim 26, wherein the organic or inorganic flame retardant is contained in an amount of 0.5 to 5% by weight

28. The two-component foam system of claim 25, wherein the flame retardant is selected from a group consisting of red phosphorus, a phosphorus compound, and antimony oxide.

29. The two-component foam system of claim 28, wherein the phosphorus compound is selected from a group containing triethyl phosphate, triphenyl phosphate, a halogenated phosphat ester, trichloroethyl phosphate, tris (2-chloroisopropyl) phosphate, tris (2 choloroethyl) phosphate, ammonium polyphosphate; and the metal hydroxide is selected from a group containing aluminum hydroxide and magnesium hydroxide.

30. The two-component foam system of claim 1, wherein the polyol component (A) contains an agent for accelerating the coagulation of the polymer dispersion.

31. The two-component foam system of claim 30, wherein the polyol component (A) contains one of a finely divided solid, a salt, an oxide of a multivalent, metal and an organic acid as the agent for accelerating the coagulation.

32. The two-component foam system of claim 31, wherein a multivalent metal is selected from a group consisting of alkaline earth elements, zinc, aluminum, and iron.

33. The two-component foam system of claim 31, wherein the polyol component (A) contains at least one of finely divided inorganic filler and organic filler as the agent for accelerating the coagulation.

34. The two-component foam system of claim 31, wherein the polyol component (A) contains at least one finely divided inorganic filler selected from the group consisting of metal oxides, borates, carbonates, silicates, kaolin, glass powder, iron oxide, titanium oxides, silica, inorganic foams, and hollow spheres of silicate material or glass.

35. The two-component foam system of claim 34, wherein chalk is used as a carbonate, and wherein the foam is selected from the group consisting of foamed expanded, clay, foamed perlite, and foamed vermiculite.

36. The two-component foam system of claim 31, wherein the polyol component (A) contains at least one of particulate or fibrous vegetable and animal polymers as the agent for accelerating the coagulation.

37. The two-component foam system of claim 36, wherein the vegetable polymers are based on potatoes, corn, rice, grain, wood, cork, paper, leather, cellulose, hemp, cotton, and the animal polymer is based on wool.

38. The two-component foam system of claim 31, wherein the polyol component (A) contains calcium nitrate, zinc nitrate, zinc oxide, aluminum sulfate, aluminum chloride, iron sulfate, iron chloride, formic acid, acetic acid, polyacrylamide, and ammonium polyphosphate as the agent for accelerating the coagulation.

39. The two-component foam system of claims 30, wherein the polyol component (A) further contains a coagulating aid.

40. The two-component foam system of claim 39, wherein one of ester alcohol and glycol is used as the coagulation aid.

41. The two-component foam system of claim 39, wherein 2,2,4-trimethyl-1,3-dihydroxypentane monoisobutyrate is used as the coagulation aid.

42. The two-component foam system claim 1, wherein at least one of the polyol component (A) and the polyisocyanate component (B) contains at least one of a thixotropic agent and a diluent or solvent.

43. The two-component foam system of claim 42, wherein at least one of silica, phyllosilicate, an activated bentonite, sepionite or attapulgite, polyethylene wax, and cellulose derivatives, is contained as the thixotropic agent.

44. The two-component foam system of claim 42, wherein at least one of a synthetic magnesium phyllosilicate and hydroxyethylcellulose is used as the thixotropic agent.

45. The two-component foam system of claim 42, wherein an aliphatic alcohol is contained as diluent or solvent.

46. The two-component foam system of claim 42, wherein one of butanol and dipropylene glycol is used as diluent or solvent.

47. The two-component foam system of claim 1, wherein at least one of the polyol component (A) and the polyisocyanate component (B) additionally contains at least one of inorganic filler and organic filler.

48. The two-component foam system of claim 47, wherein at least one of metal oxide, a borate, a carbonate, a silicate, kaolin, glass powder, iron oxide, titanium oxide, silica, an inorganic foam, and hollow sphere of a silicate material or glass is contained as the inorganic filler.

49. The two-component foam system of claim 48, wherein an inorganic foam is selected from the group consisting of foamed expanded clay, foamed perlite, and foamed vermiculite, and a chalk is used as carbonate.

50. The two-component foam system of claim 47, wherein at least one of particulate vegetable polymer, fibrous vegetable polymer, and animal polymer, is contained as the organic filler.

51. The two-component foam system of claim 50, wherein the particulate vegetable polymer and the fibrous vegetable polymer are based on potatoes, corn, rice, grain, wood, cork, paper, cellulose, hemp, cotton, and starch, and the animal polymer is based on leather and wool.

52. The two-component foam system of claim 1, wherein at least one of the polyol component (A) and the polyisocyanate component (B) additionally contains at least one of known auxiliary materials, additives, stabilizers, plasticizers, catalysts, solvents, pigments, and dyes.

53. The two-component foam system of claim 52, wherein at least one of ester, based phthalic acid, adipic acid, sebacic acid, phosphoric acid, citric acid, and a fatty acid is contained as the plasticizer.
